(19) United States
(12) Patent Application Publication
(10) Pub. No.: US 2025/0308733 A1
(43) Pub. Date: Oct. 2, 2025

(54) CERAMIC COMPONENT

(71) Applicant: Panasonic Intellectual Property Management Co., Ltd., Osaka (JP)

(72) Inventors: DAIKI NAKAYAMA, Hokkaido (JP); YASUTAKA OKAMOTO, Hokkaido (JP); NAOKI MUTOU, Hokkaido (JP); SATOSHI KAWAMURA, Hokkaido (JP)

(21) Appl. No.: 19/069,322

(22) Filed: Mar. 4, 2025

(30) Foreign Application Priority Data
Mar. 27, 2024 (JP) 2024-052372

(51) Int. Cl. H01C 7/112; C04B 35/453; H01C 1/148; H01C 7/102

(52) U.S. Cl. CPC H01C 7/112; C04B 35/453; H01C 1/148; H01C 7/102

(57) ABSTRACT

A ceramic component having improved insulation properties is provided. The ceramic component includes a ceramic body, an internal electrode provided inside the ceramic body, an insulation layer covering a surface of the ceramic body, and an external electrode covering a part of the insulation layer and electrically connected to the internal electrode. The insulation layer includes a first layer 13X in contact with the ceramic body, and a second layer provided on the first layer on the side opposite to the ceramic body.

### BACKGROUND

### 1. Technical Field

The present disclosure relates to a ceramic component, and more particularly to a ceramic component including an insulation layer.

### 2. Description of the Related Art

Various ceramic components such as varistors are used for various electronic apparatuses, electronic devices, and the like. Varistors are used for the purposes of protecting various electronic apparatuses, electronic devices, and the like from abnormal voltages caused by lightning surges, static electricity, and the like, and preventing malfunctions of the electronic apparatuses, the electronic devices, and the like due to noise generated in circuits, and other purposes.

PTL 1 discloses a laminated chip varistor including a laminate having a varistor layer and an internal electrode and an external electrode, and describes a method for improving ESD resistance.

### CITATION LIST

### Patent Literature

PTL 1: Unexamined Japanese Patent Publication No. 2007-080950

### SUMMARY

The laminated chip varistor described in PTL 1 does not have an insulation layer, but a ceramic component such as a varistor is generally provided with an insulation layer covering a surface of a ceramic body for the purpose of improving insulation properties between an internal electrode and an external electrode in order to improve electrical characteristics such as reduction of leak current. When Al₂O₃ having higher electric resistance is used as the material of the insulation layer, the ceramic component has a problem that the insulation properties cannot be improved and that characteristics such as varistor characteristics degrade.

An object of the present disclosure is to provide a ceramic component having improved insulation properties.

A ceramic component according to an aspect of the present disclosure includes a ceramic body, an internal electrode provided inside the ceramic body, an insulation layer covering a surface of the ceramic body, and an external electrode covering a part of a surface of the insulation layer and electrically connected to the internal electrode. The insulation layer includes a first layer in contact with the ceramic body, and a second layer provided on the first layer on a side opposite to the ceramic body.

According to the present disclosure, it is possible to provide a ceramic component having improved insulation properties.

### BRIEF DESCRIPTION OF THE DRAWINGS

FIG. 1 is a schematic cross-sectional view illustrating an example of a ceramic component according to the present exemplary embodiment.

### DETAILED DESCRIPTIONS

### 1. Outline

An outline of ceramic component 1 will be described below with reference to the drawings. Note that the drawings are schematic diagrams, and the ratios of the size and thickness of each component in the drawings does not necessarily reflect the actual dimensional ratios.

As described above, for example, in a case where Al₂O₃ is used as a material of an insulation layer in a ceramic component, Al₂O₃ as a main component of the insulation layer and ZnO as a main component of a ceramic body are diffused into each other, a reaction such as solid solution occurs, and both the insulation layer and the ceramic body are altered due to a high temperature at which firing or the like is performed during manufacturing of the ceramic component. As described above, in a case where a material having high reactivity with the main component of the ceramic body is used as the material of the insulation layer, the insulation properties of the ceramic component cannot be improved, and the varistor characteristics and the like degrade.

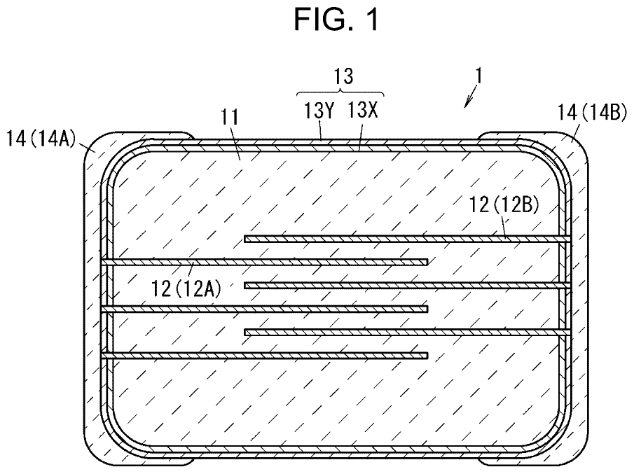

As illustrated in FIG. 1, ceramic component 1 according to the present exemplary embodiment includes ceramic body 11, internal electrode 12 provided inside ceramic body 11, insulation layer 13 covering a surface of ceramic body 11, and external electrode 14 covering a part of insulation layer 13 and electrically connected to internal electrode 12. Insulation layer 13 includes first layer 13X in contact with ceramic body 11, and second layer 13Y provided on first layer 13X on the side opposite to ceramic body 11.

Ceramic component 1 according to the present exemplary embodiment includes, as insulation layer 13, two layers which are first layer 13X in contact with ceramic body 11 and second layer 13Y on the external electrode 14 side. In ceramic component 1, the insulation properties can be improved by adopting such a layer configuration of insulation layer 13. This improvement in insulation properties is presumed to be because, for example, a boundary between the two layers acts as a barrier layer, and the insulation resistance increases.

### 2. Details

### Ceramic Component

Ceramic component 1 according to the present exemplary embodiment includes ceramic body 11, internal electrode 12, insulation layer 13, and external electrode 14, and may further include a plating electrode. Examples of ceramic component 1 according to the present exemplary embodiment include a varistor, a thermistor, and a ceramic capacitor. A case where ceramic component 1 according to the present exemplary embodiment is varistor 1 will be described as an example.

At least a pair of internal electrodes 12 and a pair of external electrodes 14 may be provided in varistor 1. In varistor 1 illustrated in FIG. 1, the number of internal electrodes 12 is 6 (3 pairs), and the number of external electrodes 14 is 2 (1 pair). Internal electrode 12 includes, for example, three first internal electrodes 12A and three second internal electrodes 12B. External electrode 14 includes, for example, first external electrode 14A provided on one end surface of ceramic body 11 and second external electrode 14B provided on the other end surface of ceramic body 11. First internal electrode 12A is electrically connected to first external electrode 14A, and second internal electrode 12B is electrically connected to second external electrode 14B. In varistor 1, one of first external electrode 14A and second external electrode 14B serves as an electrode on the high potential side, and the other of first external electrode 14A and second external electrode 14B serves as an electrode on the low potential side.

### Ceramic Body

In varistor 1, ceramic body 11 includes, for example, a semiconductor ceramic component having non-linear resistance characteristics. Ceramic body 11 usually contains ZnO as a main component, and may contain Bi₂O₃, Co₂O₃, MnO₂, Sb₂O₃, Pr₆O₁₁, CaCO₃, Cr₂O₃, or the like as an accessory component. Ceramic body 11 is formed by solid solution sintering of the main component such as ZnO with a part of the accessory component in a semiconductor ceramic component, and precipitation of the remaining accessory component at grain boundaries between the main and accessory components.

### Internal Electrode

Internal electrode 12 is provided inside ceramic body 11. Internal electrode 12 contains, for example, a metal such as Ag, Pd, PdAg, or PtAg. Ceramic body 11 having internal electrode 12 inside is formed, for example, by laminating and firing ceramic sheets coated with an internal electrode paste containing any one or more of these metals.

### Insulation Layer

Insulation layer 13 covers the surface of ceramic body 11. Insulation layer 13 may cover a part of ceramic body 11, or may cover the entire surface of ceramic body 11.

Insulation layer 13 includes first layer 13X and second layer 13Y. First layer 13X is a layer in contact with ceramic body 11. Second layer 13Y is a layer provided on first layer 13X on the side opposite to ceramic body 11.

The average thickness of each of first layer 13X and second layer 13Y is, for example, greater than or equal to 1 nm and less than or equal to 1000 nm, and preferably greater than or equal to 10 nm and less than or equal to 200 nm. The “average thickness” means an arithmetic average value of thicknesses measured at a plurality of points (for example, arbitrary 10 points) in a cross section of the ceramic component.

The average thickness of second layer 13Y may be equal to or different from the average thickness of first layer 13X, and the average thickness of second layer 13Y may be greater than the average thickness of first layer 13X. When the thickness of second layer 13Y is made greater than the thickness of first layer 13X, the mechanical strength of ceramic component 1 can be further improved.

Examples of a material constituting each of first layer 13X and second layer 13Y include SiO₂, Al₂O₃, and ZrO₂.

A composition of first layer 13X and a composition of second layer 13Y are preferably different. By using first layer 13X and second layer 13Y having different compositions, the insulation properties can be further improved. The “composition” means the types of substances and the like constituting each layer and the content ratios (% by mass) of these substances. The fact that “the compositions are different” between the layers means that 95% by mass or more of a substance constituting first layer 13X and 95% by mass or more of a substance constituting second layer 13Y are different.

A coefficient of thermal conductivity of first layer 13X is preferably higher than a coefficient of thermal conductivity of second layer 13Y. By making the coefficient of thermal conductivity of first layer 13X higher than the coefficient of thermal conductivity of second layer 13Y, the insulation properties of second layer 13Y, which is a layer on the side on which a surface of insulation layer 13 is present, can be made higher than that of first layer 13X, which is a layer on the side opposite to the surface of insulation layer 13, and by adopting such an arrangement, the insulation properties of ceramic component 1 can be further improved.

Reactivity between a main component of ceramic body 11 and a main component of first layer 13X is preferably lower than reactivity between the main component of ceramic body 11 and a main component of second layer 13Y. In this case, it is possible to improve the insulation properties while maintaining the characteristics of both ceramic body 11 and insulation layer 13. The term “reactivity” means case of mutual diffusion and case of solid solution of the main components between the layers, and specifically refers to, for example, reactivity at a temperature (about 600° C. to 1100° C.) during firing after coating in formation of insulation layer 13 of ceramic component 1.

That is, even in a case where the material of insulation layer 13 is, for example, a material having high reactivity with ceramic body 11, the material is used for second layer 13Y, and a material having low reactivity with second layer 13Y and low reactivity with ceramic body 11 is used as the material of first layer 13X in contact with ceramic body 11, thereby making it possible to improve the insulation properties of insulation layer 13 of ceramic component 1 while maintaining the characteristics of both ceramic body 11 and insulation layer 13.

As a combination of the materials of first layer 13X and second layer 13Y, it is preferable that first layer 13X contain SiO₂ and second layer 13Y contain Al₂O₃. In these cases, it is possible to obtain excellent insulation properties while maintaining characteristics such as varistor characteristics.

Insulation layer 13 may further include a third layer (hereinafter, also referred to as third layer 13Z) provided on second layer 13Y on the side opposite to first layer 13X, and may further include a fourth layer (hereinafter, also referred to as fourth layer 13W) provided on third layer 13Z on the side opposite to second layer 13Y. In these cases, the insulation properties can be further improved by increasing the number of barrier layers at boundaries between the layers, and the like.

It is preferable that first layer 13X to fourth layer 13W have the same layer configuration repeatedly. That is, it is preferable that the composition of first layer 13X be identical to a composition of third layer 13Z, and the composition of the second layer 13Y be identical to a composition of the fourth layer 13W. In this case, the insulation properties can be further improved.

Insulation layer 13 may include, in addition to first layer 13X to fourth layer 13W, fifth to nth layers (n is an integer greater than or equal to 5) in this order. In these cases, insulation properties can be further improved. n is preferably greater than or equal to 7, and more preferably greater than or equal to 9. The upper limit of n is, for example, less than or equal to 100.

The average thickness of insulation layer 13, that is, the total average thickness of first layer 13X to the nth layer is, for example, greater than or equal to 10 nm and less than or equal to 1000 nm, and preferably greater than or equal to 100 nm and less than or equal to 300 nm.

Each of the layers constituting insulation layer 13 is preferably formed using atomic layer deposition (ALD). When an insulation layer is formed by using PVD or CVD as in the related art, it is difficult to form a uniform coating film as in ALD. Therefore, for example, a large number of thin portions or uncoated portions are generated in a first layer, and a second layer and a ceramic body come into contact with each other and react with each other, resulting in degradation of varistor characteristics and the like. Each of the layers having different compositions can be formed by changing a precursor or the like in ALD. Since ALD is used, even in a case where the thickness of each of the layers to be formed is small and the number of layers is large, uniform insulation layer 13 can be easily and reliably formed. Insulation layer 13 is usually formed by firing the layers formed by ALD or the like at a temperature in a range from about 600° C. to about 1100° C.

### External Electrode

External electrode 14 covers at least a part of insulation layer 13 and is electrically connected to internal electrode 12.

External electrode 14 contains, for example, a metal component such as Ag, AgPd, or AgPt, and a glass component such as Bi₂O₃, SiO₂, or B₂O₃. External electrode 14 preferably contains a metal as a main component, and more preferably contains Ag as a main component.

External electrode 14 may have a single-layer structure (external electrode 14A and external electrode 14B) or a multilayer structure having a plurality of layers.

External electrode 14 is usually formed by applying an external electrode paste containing the metal component to a part of the surface of insulation layer 13 and performing baking.

### Plating Electrode

The plating electrode covers at least a part of external electrode 14. The plating electrode includes, for example, a Ni electrode covering at least a part of external electrode 14, and a Sn electrode covering at least a part of the Ni electrode.

It is considered that ceramic component 1 according to the present exemplary embodiment, such as a thermistor and a ceramic capacitor other than varistor 1, can have improved insulation properties.

### Method for Manufacturing Ceramic Component

The method for manufacturing the ceramic component according to the present exemplary embodiment includes a first step, a second step, and a third step. The method for manufacturing the ceramic component may further include a step of forming the plating electrode as a fourth step.

### First Step

In the first step, ceramic body 11 having internal electrode 12 inside is formed.

In the first step, for example, an internal electrode paste is applied to ceramic sheets prepared using a slurry containing ZnO, and the ceramic sheets are laminated, pressed, and cut, and then debound and fired to prepare ceramic body 11 having internal electrode 12 inside. The slurry can be prepared, for example, by mixing ZnO as a main raw material, Bi₂O₃, Co₂O₃, MnO₂, Sb₂O₃, Pr₆O₁₁, CaCO₃, Cr₂O₃, or the like as a sub-raw material, and a binder.

For example, an Ag paste, a Pd paste, a Pt paste, a PdAg paste, a PtAg paste, or the like can be used as the internal electrode paste.

The temperature at which the debinding is performed is, for example, higher than or equal to 300° C. and lower than or equal to 500° C. The temperature at which the firing is performed can be appropriately adjusted based on the configuration, composition, and the like of ceramic body 11 to be obtained, and is, for example, higher than or equal to 800° C. and lower than or equal to 1300° C.

### Second Step

In the second step, the plurality of layers is laminated as insulation layer 13 on the surface of ceramic body 11. That is, the second step is a step of sequentially forming the plurality of layers from the first layer to the nth layer on the surface of ceramic body 11. In the second step, usually, after the formation of the plurality of layers, the firing is performed after the coating. In this manner, insulation layer 13 can be formed. In addition, instead of performing the firing after the coating in the second step, the external electrode may be baked in the third step, whereby insulation layer 13 may be formed.

Examples of a method for forming each of the layers in the second step include a method using atomic layer deposition (ALD).

In ALD, a gaseous precursor is introduced to a surface on which ceramic body 11 and a layer such as a SiO₂ layer is to be formed, the surface is irradiated with O₂ plasma, Ar plasma, or the like, and these processes are repeated, whereby each of the layers including an atomic layer deposit can be formed. In addition, the layers having different compositions can be formed by repeating the above operation while changing the type of precursor.

As the precursor, for example, bis(ethylmethylamino)silane(BEMAS) or the like is used for forming SiO₂, and trimethylaluminum or the like is used for forming Al₂O₃. In addition, in order to form SiO₂ and Al₂O₃, irradiation with O₂ plasma is performed.

The temperature at which the firing is performed after the coating is usually in a range from about 600° C. to about 900° C., and preferably higher than or equal to 700° C. and lower than or equal to 800° C.

### Third Step

In the third step, external electrode 14 is formed on a part of the surface of insulation layer 13.

In the third step, for example, an external electrode paste is applied to a part of the surface of insulation layer 13 so as to be in contact with a part of internal electrode 12, and then baked to form external electrode 14. The external electrode paste can be prepared by mixing, for example, a metal component containing Ag powder, AgPd powder, AgPt powder, or the like, a glass component containing Bi₂O₃, SiO₂, B₂O₃, or the like, and a solvent. In addition, a paste containing Ag as a main component and containing a resin component or the like can also be used as the external electrode paste. Examples of a method for applying the external electrode paste include immersion and printing. The temperature at which the baking is performed is, for example, higher than or equal to 700° C. and lower than or equal to 800° C.

### Fourth Step

In the fourth step, the plating electrode is formed so as to cover at least a part of external electrode 14. As a method for forming the plating electrode, for example, Ni plating and Sn plating are sequentially performed by an electrolytic plating method.

### EXAMPLES

The present disclosure will be described below in more detail based on Examples, but the present disclosure is not limited to Examples.

### Manufacturing of Ceramic Component

Ceramic components according to Comparative Example 1 and Examples 1 and 2 were manufactured by forming a SiO₂ layer and an Al₂O₃ layer on a surface of a ceramic body containing ZnO as a main component using atomic layer deposition (ALD) or repeating the formation so as to have the following layer configuration.

### Comparative Example 1

An Al₂O₃ monolayer (average thickness of the layer: 200 μm)

### Example 1

A first layer: SiO₂, and a second layer: Al₂O₃ (average thickness of each of the layers: 100 μm)

### Example 2

First, third, fifth, seventh, and ninth layers: SiO₂, and second, fourth, sixth, eighth, and tenth layers: Al₂O₃ (average thickness of each of the layers: 20 μm)

The formation of the SiO₂ layers and the Al₂O₃ layers by ALD was performed as follows.
Each of the SiO₂ layers: Bis(ethylmethylamino)silane(BEMAS) was introduced as a precursor to form a Si-containing layer, and then the Si-containing layer was purged. Next, the formed Si-containing layer was irradiated with O₂ plasma to form the SiO₂ layer.
Each of the Al₂O₃ layers: trimethylaluminum was introduced as a precursor to form an Al-containing layer, and then the Al-containing layer is purged. Next, the formed Al-containing layer was irradiated with O₂ plasma to form the Al₂O₃ layer.

The insulation properties of each of the manufactured ceramic components were evaluated by the following method.

### Evaluation

### Insulation Properties

As the evaluation of the insulation properties, for products with the ceramic components mounted thereon, polarity differences (difference in V_{1 μA} when a voltage was applied in a positive direction and a negative direction) when V_{1 μA} was applied after an accelerated moisture resistance test in a pressure cooker bias test (PCBT) was performed for 48 hours was measured. The smaller the value of the polarity difference when V_{1 μA} is applied is, the better the insulation properties are.

The results of evaluating the insulation properties are shown in the following Table 1 together with the numbers of layers constituting the insulation layers and the layer configurations.

TABLE 1

| | | | Results of |
|---|---|---|---|
| | | | evaluating |
| | | | insulating |
| | | | properties |
| | The | | (polarity |
| | number of | | difference in |
| | layers | Layer | V_{1μA} after PCBT |
| | constituting | configuration of | performed |
| | insulating layer | insulating layer | for 48 hours) |
| Comparative | One layer | Al₂O₃ monolayer | 1.38 |
| example 1 | | | |
| Example 1 | Two layers | First layer: SiO₂, | 0.26 |
| | | Second layer: Al₂O₃ | |
| Example 2 | Multiple layers | First, third, fifth, seventh, | 0.14 |
| | (ten layers) | and ninth layers: SiO₂ | |
| | | Second, fourth, | |
| | | sixth, eighth, | |
| | | and tenth layers: Al₂0₃ | |

As is apparent from the results shown in Table 1, the ceramic components according to Examples 1 and 2 have improved insulation properties as compared with those of the ceramic component according to Comparative Example 1. In addition, as can be seen from the comparison between Example 2 and Example 1, the insulation properties are further improved as the number of layers constituting the insulation layer is larger.

### Conclusions

As apparent from the above exemplary embodiments, the present disclosure includes the following aspects. In the following, reference signs are given in parentheses only to clarify the correspondence relationship with the exemplary embodiments.

A ceramic component (1) according to a first aspect includes a ceramic body (11), an internal electrode (12) provided inside the ceramic body (11), an insulation layer (13) covering a surface of the ceramic body (11), and an external electrode (14) covering a part of a surface of the insulation layer (13) and electrically connected to the internal electrode (12). The insulation layer (13) has a first layer (13X) in contact with the ceramic body (11), and a second layer (13Y) provided on the first layer (13X) on a side opposite to the ceramic body (11).

According to the first aspect, the ceramic component (1) can have improved insulation properties.

In the ceramic component (1) according to a second aspect, in the first aspect, a composition of the first layer (13X) is different from a composition of the second layer (13Y).

According to the second aspect, the ceramic component (1) can have further improved insulation properties.

In the ceramic component (1) according to a third aspect, in the first or second aspect, reactivity between a main component of the ceramic body (11) and a main component of the first layer (13X) is lower than reactivity between the main component of the ceramic body (11) and a main component of the second layer (13Y).

According to the third aspect, the ceramic component (1) can have improved insulation properties while maintaining the characteristics of both the ceramic body (11) and the insulation layer (13).

In the ceramic component (1) according to a fourth aspect, in any one of the first to third aspects, a coefficient of thermal conductivity of the first layer (13X) is higher than a coefficient of thermal conductivity of the second layer (13Y).

According to the fourth aspect, the ceramic component (1) can have further improved insulation properties.

In the ceramic component (1) according to a fifth aspect, in any one of the first to fourth aspects, the ceramic body (11) contains ZnO as a main component, the first layer (13X) contains SiO₂, and the second layer (13Y) contains Al₂O₃.

According to the fifth aspect, the ceramic component (1) can have excellent insulation properties while maintaining characteristics such as varistor characteristics.

In the ceramic component (1) according to a sixth aspect, in any one of the first to fifth aspects, an average thickness of the second layer (13Y) is greater than an average thickness of the first layer (13X).

According to the sixth aspect, the ceramic component (1) can have improved mechanical strength and the like.

In the ceramic component (1) according to a seventh aspect, in any one of the first to sixth aspects, the insulation layer (13) further includes a third layer (13Z) provided on the second layer (13Y) on a side opposite to the first layer (13X).

According to the seventh aspect, the ceramic component (1) can have further improved insulation properties.

In the ceramic component (1) according to an eighth aspect, in the seventh aspect, the insulation layer (13) further includes a fourth layer (13W) provided on the third layer (13Z) on a side opposite to the second layer (13Y).

According to the eighth aspect, the ceramic component (1) can have further improved insulation properties.

What is claimed is:

1. A ceramic component comprising:
a ceramic body;
an internal electrode provided inside the ceramic body;
an insulation layer covering a surface of the ceramic body; and
an external electrode provided to cover a part of the insulation layer and electrically connected to the internal electrode,
wherein the insulation layer includes a first layer in contact with the ceramic body and a second layer provided on a surface of the first layer, the surface being on a side opposite to the ceramic body.

2. The ceramic component according to claim 1, wherein a composition of the first layer is different from a composition of the second layer.

3. The ceramic component according to claim 1, wherein reactivity between a main component of the ceramic body and a main component of the first layer is lower than reactivity between the main component of the ceramic body and a main component of the second layer.

4. The ceramic component according to claim 1, wherein a coefficient of thermal conductivity of the first layer is higher than a coefficient of thermal conductivity of the second layer.

5. The ceramic component according to claim 1, wherein
the ceramic body contains ZnO as a main component,
the first layer contains SiO₂, and
the second layer contains Al₂O₃.

6. The ceramic component according to claim 1, wherein an average thickness of the second layer is greater than an average thickness of the first layer.

7. The ceramic component according to claim 1, wherein the insulation layer further includes a third layer provided on a surface of the second layer, the surface being on a side opposite to the first layer.

8. The ceramic component according to claim 7. wherein the insulation layer further includes a fourth layer provided on the third layer on a side opposite to the second layer.
